(19) United States
(12) Patent Application Publication
(10) Pub. No.: US 2025/0074363 A1
(43) Pub. Date: Mar. 6, 2025

(54) VEHICLE FLAT WIPER

(71) Applicant: THE MITA COMPANY, LTD, Tokyo (JP)

(72) Inventor: Masato ZUKOSHI, Kamakura (JP)

(73) Assignee: THE MITA COMPANY, LTD, Tokyo (JP)

(21) Appl. No.: 18/031,600

(22) PCT Filed: Mar. 25, 2022
(86) PCT No.: PCT/JP2022/014419

§ 371 Date: Nov. 22, 2024

(51) Int. Cl. B60S 1/34; B60S 1/38

(52) U.S. Cl. CPC B60S 1/34; B60S 2001/3812

(57) ABSTRACT

A conventional vehicle wiper does not allow the longitudinal size after packaging to be made smaller than the length of the wiper, and thus there is a limit to the reduction of transport cost and storage cost by size reduction. A vehicle wiper according to the present invention includes a blade rubber that wipes a windshield; a leaf spring that uniformly presses the blade rubber against the windshield; a frame that integrally supports the blade rubber and the leaf spring; and a clip that couples the frame to a wiper arm, wherein the frame is made up of first and second frames, the leaf spring is made up of first and second leaf springs, the first and second leaf springs contained in the first and second frames, respectively, and the first and second frames are coupled to opposite sides of the clip, respectively, and the blade rubber is adapted to be attached finally. Also, the first and second frames containing the first and second leaf springs, respectively, the clip, and the blade rubber are packed into a single package in a divided state at the factory.

### TECHNICAL FIELD

The present invention relates to a wiper used to wipe a windshield and the like of a vehicle, and more particularly, to the structure of a flat wiper.

### BACKGROUND OF THE INVENTION

Typical conventional vehicle wipers include a blade rubber that wipes out raindrops or dust adhering to a windshield by coming into direct contact with the raindrops or dust, a support that supports the blade rubber, a clip that couples a wiper arm to the support in order to drive the wiper along an arc, a yoke that uniformly presses the support against the windshield, and the like.

To wipe out raindrops or dust uniformly, it is necessary to press the blade rubber against a surface of the windshield by uniform force. Conventionally, mainstream has been a structure (tournament wiper) in which plural yokes are placed branching out from a wiper arm in the form of a tournament chart to press against the blade rubber at a plurality of points. Recently, however, a flat wiper of a yokeless configuration such as exemplified in FIG. 1 has been on the market as well. The flat wiper includes a clip 2 in the center of a support 1, a leaf spring 3 is inserted and held in a groove provided in the support 1, and a blade rubber 4 held similarly is pressed to conform to the curve of the windshield by elasticity of the leaf spring 3. The flat wiper has the advantage of being able to avoid a problem with the tournament wiper, i.e., the problem of a floating blade during high-speed running, and provide a neat appearance as well (Patent Literatures 1 to 4).

### CITATION LIST OF PATENT LITERATURE

PATENT LITERATURE 1: Japanese Patent No. 3590779
PATENT LITERATURE 2: JP-A-2007-276724
PATENT LITERATURE 3: Japanese Patent No. 6968958
PATENT LITERATURE 4: Japanese Patent No. 4985058

### SUMMARY OF INVENTION

### Technical Problem

The flat wiper structured such that one leaf spring is contained in a frame has its parts completely assembled at the factory, has its product performance, including safety and strength, checked in the assembled state, and then comes onto the market after going through quality control inspections. At the time of shipment, it is necessary to minimize packaging from the viewpoint of transport. However, in the case of a conventional flat wiper containing one leaf spring, it is difficult to fold the leaf spring in two for packaging because of the fear of plastic deformation, unlike the blade rubber. Therefore, it is not possible to make longitudinal size after packaging smaller than the length of the wiper. Thus, there is a limit to further reduction of transport cost and storage space by reducing packaging size.

### Solution to Problem

Having a structure in which a leaf spring is divided into two in the center, a flat wiper according to the present invention is packed into a single package by being divided into parts, and thus allows its longitudinal size after packaging to be reduced greatly.

A flat wiper according to the present invention is configured as follows.

The flat wiper includes a blade rubber that wipes a windshield; a leaf spring that uniformly presses the blade rubber against the windshield; a frame that integrally supports the blade rubber and the leaf spring; and a clip that couples the frame to a wiper arm, wherein the frame is made up of first and second frames, the leaf spring is made up of first and second leaf springs, the first and second leaf springs contained in the first and second frames, respectively, and the first and second frames are coupled to opposite sides of the clip, respectively, and the blade rubber is adapted to be attached finally.

Furthermore, portions of the first and second leaf springs contained in the first and second frames, respectively, may be exposed outside the frame and the exposed portions may be inserted into, fixed to, and coupled to opposite ends of the clip.

Furthermore, a corrosion-resistant tube may be placed between the portions of the first and second leaf springs that are exposed outside the frame and a coupling portion of the clip.

Also, with the flat wiper according to the present invention, the first and second frames containing the first and second leaf springs, respectively, the clip, and the blade rubber are packed into a single package in a divided state at a factory and are distributed so that a user may unpack the package, fix and couple the first and second frames to the clip, and subsequently attach the blade rubber to obtain a finished product of the vehicle wiper.

With conventional flat wipers, there are cases in which the support (vertebra) of the blade rubber is made up of plural parts stacked in a thickness direction (Patent Literatures 1 and 2), but there has never been a case in which the leaf spring has been divided into two in the longitudinal direction from the center.

### Advantageous Effects of Invention

Since the structure of the wiper according to the present invention is structured such that the leaf spring is divided into two at the center, the longitudinal size after packaging can be nearly halved. The transport cost, which depends mainly on external size rather than weight, can be reduced greatly compared to the conventional wipers. Also, less inventory space is required, resulting in reduced storage cost.

### BRIEF DESCRIPTION OF DRAWINGS

FIG. 1 shows an example of the structure of a conventional flat wiper containing a single leaf spring;

FIG. 2 is an exploded view showing the component configuration of a flat wiper according to a first embodiment of the present invention;

FIG. 3 is a perspective view showing an assembly process of the flat wiper according to the first embodiment of the present invention as viewed from above;

FIG. 4 is a perspective view showing an assembly process of the flat wiper according to the first embodiment of the present invention as viewed from below;

FIG. 5 is a perspective view showing a coupling process of a joint between a frame end and a clip of the flat wiper according to the first embodiment of the present invention;

FIG. 6 is a perspective view of the flat wiper according to the first embodiment of the present invention after assembly as viewed from above;

FIG. 7 is an exploded view showing the component configuration of a flat wiper according to a second embodiment of the present invention;

FIG. 8 is a perspective view of the flat wiper according to the second embodiment of the present invention after assembly as viewed from above;

FIG. 9 is a longitudinal sectional view of the flat wiper according to the second embodiment of the present invention along the length after assembly (top) and an enlarged view of the encircled part (bottom); and

FIG. 10 is a general view showing a state of components of the flat wiper according to the present invention before packaging.

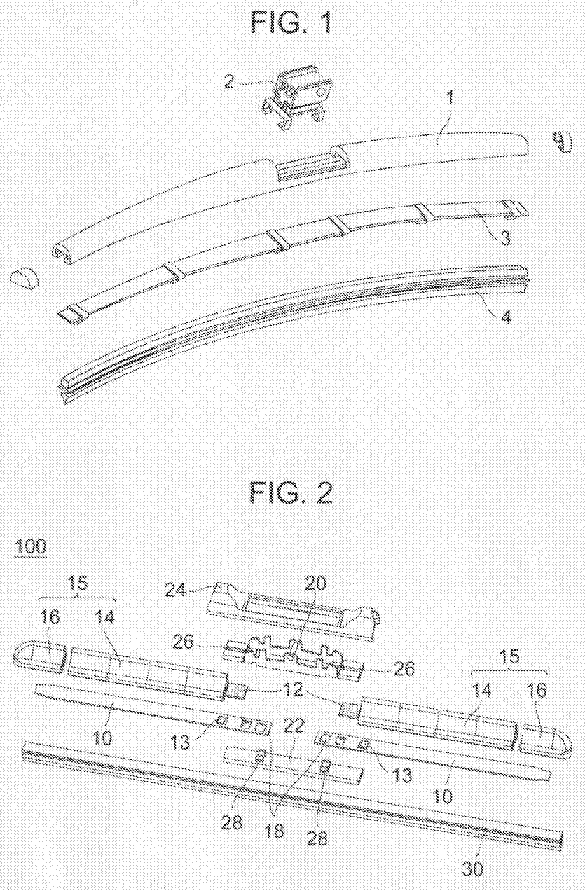

### DETAILED DESCRIPTION OF THE INVENTION

Embodiments of the present invention will be described in detail below by using the embodiments.

### Embodiment 1

FIG. 2 is a perspective view showing the component configuration of a flat wiper 100 according to a first embodiment of the present invention. The wiper includes a clip 20 coupled to a wiper arm (not shown) in the center, a coupling frame 22 and a center frame 24 engaged with the clip 20, a first frame 15 and a second frame 15 coupled to opposite sides of the clip 20, a first leaf spring 10 and a second leaf spring 10 inserted into the first and second frames 15, respectively, and blade rubber 30 which wipes a surface of a windshield by abutting the windshield. The first and second frames 15 include first and second side frames 14 on the center side of the wiper and first and second end frames 16 on the end sides, respectively. The leaf springs are made of stainless steel having elasticity, such as SK6, SK7, SUS304, SUS430, SUS302, and the clip 20 is made of galvanized sheet iron such as SGCC or SECC. The first and second frames 15, the coupling frame 22, and the center frame 24 can be made of a material such as TPR (thermoplastic elastomer), PC (polycarbonate), or ABS resin.

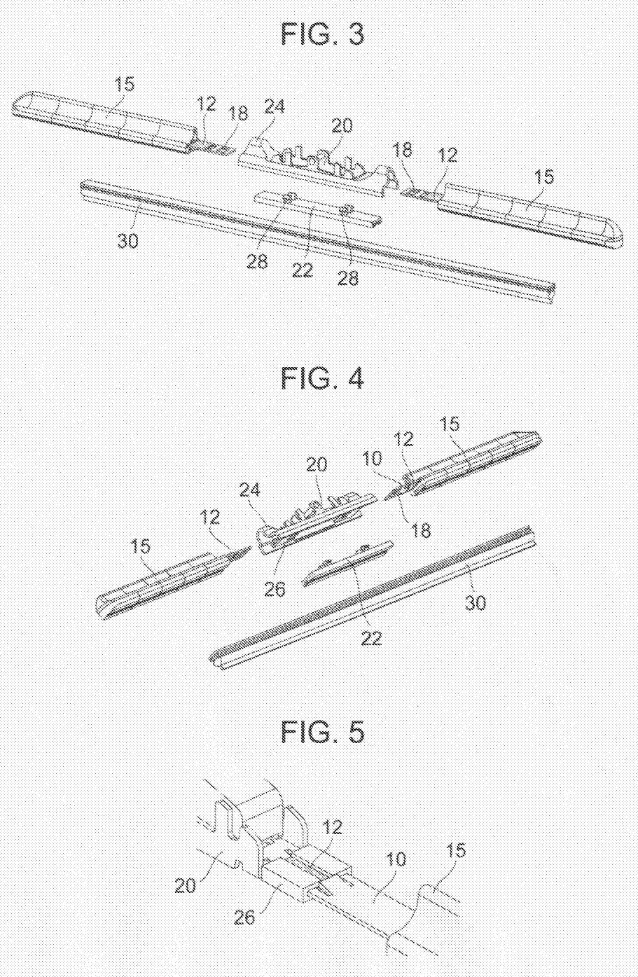

FIGS. 3 and 4 show an assembly process of the flat wiper according to the present invention. First, the first and second leaf springs 10 are inserted into the first and second side frames 14, respectively, and next the first and second end frames 16 cover the leaf springs on opposite ends, respectively, to protect the leaf springs from corrosion from the end sides. Tips of the first and second leaf springs 10 on the clip side are designed to be exposed from the first and second frames 15.

Furthermore, the tips of the first and second leaf springs 10 on the clip side are designed to penetrate first and second tubes 12, respectively, subsequently being exposed outside the tubes 12. Then, as shown in enlargement in FIG. 5, those parts of the leaf springs 10 that are covered by the tubes 12 and exposed parts of the leaf springs 10 ahead of the covered parts are inserted into first and second coupling portions 26 on opposite ends of the clip 20. The tubes 12 are fixed in predetermined positions of the leaf springs 10 by claws 13 provided on the leaf springs 10. The tubes 12 are intended to eliminate a gap between the leaf springs 10 and the coupling portions 26 of the clip made of metal and thereby prevent corrosion such as rusting caused by metal powder produced by rubbing between the two and can be made of a material such as ABS resin, PBT (polybutylene terephthalate), TPR, PC, or PP (polypropylene).

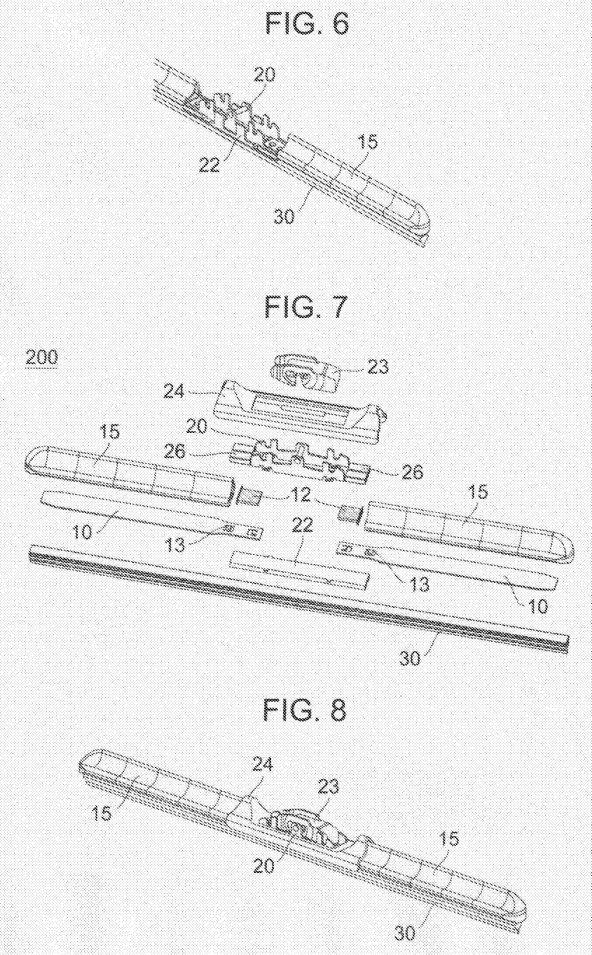

The center frame 24 is attached to the clip 20 from above. On the other hand, as shown in FIG. 3, first and second coupling protrusions 28, which are flexible, are provided on the coupling frame 22, allowing the clip 20 and the center frame 24 to be fixed together when the coupling frame 22 is inserted into the clip 20 and the center frame 24. In so doing, the first and second coupling protrusions 28 also penetrate first and second openings 18 provided, respectively, in the exposed tips of the first and second leaf springs 10 inserted into the coupling portions 26, and consequently the first and second frames 15 containing the first and second leaf springs 10 are coupled and fixed to, and thereby integrated with the clip 20 and the center frame 24. Finally, the blade rubber 30 is fitted in a guide groove in undersurfaces of the frames 15 and the coupling frame 22, thereby completing wiper assembly. A completed state is shown in FIG. 6.

### Embodiment 2

FIG. 7 is a perspective view showing the component configuration of a wiper 200 according to a second embodiment of the present invention. Components serving the same function as those of Embodiment 1 are denoted by the same reference numerals as the corresponding components of Embodiment 1. The component configuration is almost the same as Embodiment 1 and the same materials as Embodiment 1 can be used for the corresponding components. The wiper 200 includes a clip 20 and a center frame 24, a first frame 15 and a second frame 15 coupled to opposite sides of the clip 20 and center frame 24, a first leaf spring 10 and a second leaf spring 10 inserted into the first and second frames 15, respectively, and a clamping cap 23 used to couple and fix the clip 20 to the first and second leaf springs 10 in collaboration with the coupling frame 22 as well as the blade rubber 30.

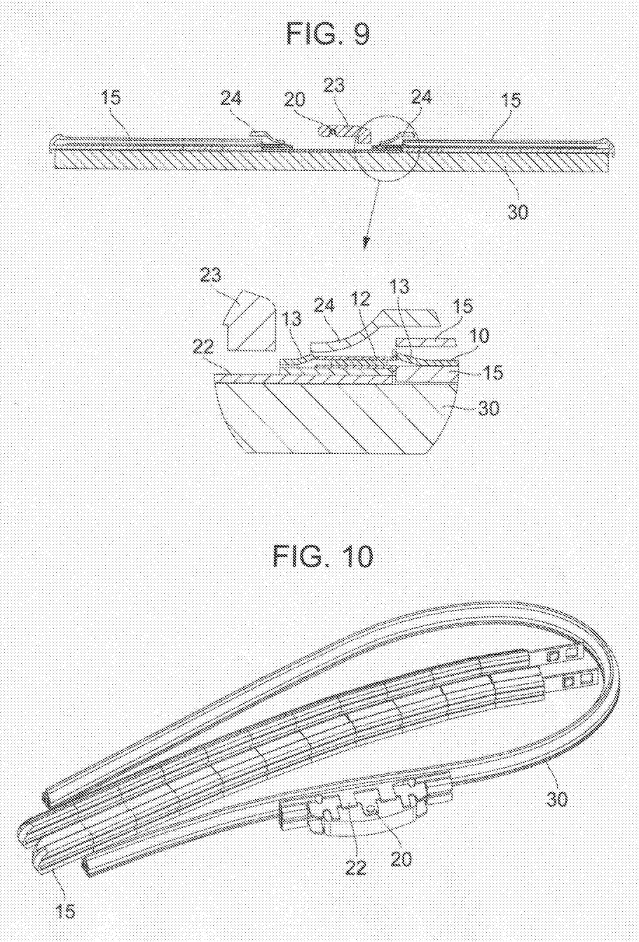

FIG. 8 shows a perspective view of the wiper 200 after completion of assembly, as viewed from above. The top half of FIG. 9 shows a longitudinal sectional view of the wiper 200 along the entire length and the bottom half of FIG. 9 shows an enlarged view of the encircled part, i.e., the coupling portion between the leaf spring 10 and the clip 20/coupling frame 22. Using the enlarged view, description will be given of a mechanism of coupling and fixing the first and second leaf springs 10 to the clip 20/coupling frame 22. Parts of the first and second leaf springs 10 on the clip side are exposed from the first and second frames 15 as with Embodiment 1, and the exposed parts are covered by the first and second tubes 12, respectively, for corrosion resistance as with Embodiment 1. On the tip of each leaf spring 10, claws 13 are provided in two places. Since the tubes 12 have elasticity, the claw 13 on the tip side of each leaf spring can be passed through the tube 12, and the leaf spring 10 is further inserted into the tube 12 until a flange-shaped part provided on the tip of the tube 12 on the side of the frame 15 abuts the other claw 13. Consequently, the position of the tube 12 on the leaf spring is fixed and the leaf spring 10 is covered by the tube 12.

On the other hand, the clip 20 has been fixed by being fitted with protrusions on lateral ends of the coupling frame 22. In this state, the tips of the leaf springs 10 with the above tubes 12 attached thereto are inserted into the coupling portions 26 of the clip 20 and the leaf springs 10/the frames 15 and the clip 20/the coupling frame 22 are coupled and fixed to each other. Subsequently, the clamping cap 23 and the center frame 24 are attached to the coupling frame 22 in sequence, and finally the blade rubber 30 is fitted in the guide groove in the undersurfaces of the frames 15 and the coupling frame 22, thereby completing wiper assembly.

As can be seen from the embodiments described above, wiper assembly according to the present invention can be carried out simply without using a tool. Note that the method for coupling the first and second frames 15 containing the first and second leaf springs 10 to the clip 20/the coupling frame 22 is not limited to the above embodiments, and another coupling mechanism may be used as long as coupling and fixing can be done easily.

Next, a method for packaging the wiper according to the present invention will be described. The conventional wiper is shipped in a finished state by being packaged after entire assembly is completed. In contrast, as shown in FIG. 10, the wiper according to the present invention is packaged and shipped by being disassembled into the first and second frames 15 containing the first and second leaf springs 10, respectively, the clip 20 and the center frame 24, and the blade rubber 30. The blade rubber 30 is packaged by being folded in the center. After unpacking the package, the user can easily obtain the finished wiper through the simple assembly as described above. The wiper according to the present invention can be packaged with the leaf spring being divided into two, and the longitudinal size after packaging can be nearly halved.

Whereas the present invention has been described based on the above embodiments, the present invention is not limited to this, and it is apparent to those skilled in the art that various changes and modifications can be made without departing from the spirt of the invention and the scope of the appended claims. For example, whereas the example of dividing the leaf spring into two has been shown in the above embodiments, the leaf spring may be divided into three or more parts and may be coupled by a member capable of maintaining elasticity of the leaf spring.

### REFERENCE SIGNS LIST

1 Support
2 Clip
3 Leaf spring
4 Blade rubber
100 Flat wiper according to the first embodiment of present invention
10 First leaf spring, second leaf spring
12 First tube, second tube
13 First claw, second claw
14 First side frame, second side frame
15 first frame, second frame
16 first end frame, second end frame
18 first opening, second opening
20 Clip
200 Flat wiper according to the second embodiment of present invention
22 Coupling frame
23 Clamping cap
24 Center frame
26 first coupling portion, second coupling portion
28 first coupling protrusion, second coupling protrusion
30 Blade rubber

1. A vehicle flat wiper comprising:
a blade rubber that wipes a windshield;
a leaf spring that uniformly presses the blade rubber against the windshield;
a frame that integrally supports the blade rubber and the leaf spring; and
a clip that couples the frame to a wiper arm, wherein the frame is made up of first and second frames, the leaf spring is made up of first and second leaf springs, the first and second leaf springs contained in the first and second frames, respectively, portions of the first and second leaf springs contained in the first and second frames, respectively, are exposed outside the frames, and the exposed portions are inserted into, fixed to, and coupled to opposite ends of the clip, a corrosion-resistant tube is placed between each of the portions of the first and second leaf springs that are exposed outside the frame and each of coupling portions at both ends of the clip, and the first and second frames are coupled to opposite sides of the clip, respectively, and the blade rubber is adapted to be attached finally.

2. (canceled)

3. (canceled)

4. (canceled)

5. A method for assembling a vehicle flat wiper, whereby the first and second frames containing the first and second leaf springs, respectively, the clip, and the blade rubber according to claim 1 are packed into a single package in a divided state at a factory and are distributed so that a user may unpack the package, fix and couple the first and second frames to the clip, and subsequently attach the blade rubber to obtain a finished product of the vehicle flat wiper.
